(19) United States
(12) Patent Application Publication
(10) Pub. No.: US 2004/0075276 A1
(43) Pub. Date: Apr. 22, 2004

(54) Clamped pipe joint, method, and pipe useful therefor

(75) Inventors: Richard G. Lemke, San Diego, CA (US); Dean B. Wehrley, Carlsbad, CA (US); Bradley L. Edgar, Oakland, CA (US)

Correspondence Address: HELLER EHRMAN WHITE & MCAULIFFE LLP, 275 MIDDLEFIELD ROAD, MENLO PARK, CA, 94025-3506, US

(73) Assignee: Cleaire Advanced Emission Controls, San Leandro, CA

(21) Appl. No.: 10/406,619

(22) Filed: Apr. 2, 2003

Related U.S. Application Data
(60) Provisional application No. 60/369,912, filed on Apr. 3, 2002.

(51) Int. Cl. F16L 17/00

(52) U.S. Cl. 285/367; 285/363

(57) ABSTRACT

A clamped pipe joint where at least one pipe has a joining end forming an expanded section of the pipe and a partially inwardly facing flare, and a clamp having a radially inwardly facing concave groove urging the pipes into sealing contact by radial compression of the clamp. The joint may be readily made and disassembled; requires no welding; and is particularly adaptable to large diameter, thin wall pipes formed from sheet metal, such as pipes forming the housings of components of internal combustion engine exhaust systems. Methods to make the joints, and pipes adapted to form the joints.

### CROSS-REFERENCE TO RELATED APPLICATION

This application claims the priority under 35 USC 119(e) of U.S. Provisional Application No. 60/369,912, filed Apr. 3, 2002, which is incorporated into this application by reference.

### BACKGROUND OF THE INVENTION

1. Field of the Invention

This invention relates to clamped pipe joints, methods to make them, and pipes for them, especially large, thin-walled pipes.

2. Description of Related Art

Joints for commercial piping systems used for the conveyance of gases or liquids are usually attached permanently or are not intended to be detached or disconnected on a regular basis. For applications using these relatively simple, fixed systems, a basic design of using overlapping pipes and various non-reusable clamps may be employed.

However, where detachment and reassembly is required for inspection and or maintenance, sections of pipes must be connected with a variety of different types of flanges and clamp systems. Typical clamps known in the art are expensive and utilize heavy flanges and thus are not amenable to a variety of different applications. In addition, the disassembly of pipes connected by commercially available clamping systems can be difficult and often requires the use of hammers and pry bars to separate previously clamped pipes. Frequently, disassembly of sealed pipes results in permanently damaging the pipes or other internal components.

A variety of clamps are commercially available and many clamps have been designed to connect pipes for exhaust systems of internal combustion engines. Most of these clamps are designed for quick and inexpensive installation during vehicle manufacture, and are not intended to be disassembled or adjusted. Typically, the design of these clamps relies on plastic deformation of metal bands, single use gaskets, or a combination of precise alignment, clean surfaces, and high clamping forces.

U.S. Pat. No. 2,009,650 discloses a flexible joint for bell and spigot pipes.

U.S. Pat. Nos. 3,788,677 and Re. 28,912 disclose an exhaust pipe joint where two pipes formed with beaded ends are axially forced together by a clamp. A gasket may be inserted between the beaded ends.

U.S. Pat. No. 3,964,773 discloses a joint which is made up of exhaust pipes formed with beaded ends or a beaded end on one pipe and a flared end on the other pipe, and a clamp having a concave groove that engages the protrusions on the ends of the pipes of the joint and wedgingly forces them together as the clamp is constricted.

U.S. Pat. No. 4,579,374 discloses a joint structure between two pipes with hollow members, one on each pipe, and a clamp embracing the hollow members. Each hollow member has a lip at its end which is adjacent to the other hollow member.

U.S. Pat. No. 5,641,185 discloses an annular clamping flange comprising a first arcuate flange portion and a second arcuate flange portion co-operable therewith to form a pipe receiving aperture, each flange portion having at least one clamping bolt receiving aperture with a longitudinal axis parallel to the longitudinal axis of the pipe receiving aperture.

Dynaflex Products (City of Commerce, California, USA) sells Expand-o-Flex™ joints, which are gasketed flexible exhaust connectors. These connectors provide a seal suitable for internal combustion system exhaust and allow some exhaust system flexibility. A suitable seal for internal combustion system is a seal that prevents a substantial amount of exhaust leakage from the exhaust system. There is no metal-to-metal contact. The joint involves four pieces: a high temperature gasket, a straight pipe, a pipe bent into a shape which holds the gasket, and a clamp to hold the joint together. This type of joint could be useful for multiple catalyst systems, but the force it can impart on the joint is not sufficient for all applications.

Other types of clamps designed for clamping and connecting pipes in exhaust systems are commercially available from Nelson (Fleetguard Inc., Nashville, Tenn., USA) and other suppliers, and include the Accuseal™, Torctite™, guillotine, flat band, and the standard U-bolt clamps. However, such clamps cannot be used on large (for example, 25-30 cm diameter) pipes, and cannot provide a suitable seal. In addition, conventional saddle or guillotine type clamps typically include multiple components, such as a yoke, bolts and nuts, which require significant handling for mounting the clamp to connecting pipes.

Telescoping tubes and wrap-around deformable clamps are also known in the art. However, these clamps require significant linear space and cannot be used in the limited spaces available for catalytic converter systems. Furthermore, these joints can be difficult to break because of thermal stress.

Typical exhaust components and pipes which comprise exhaust systems are usually exposed to corrosive environments (internally, from the hot and acidic exhaust gases; and externally, from weather and road debris) and are operated in harsh conditions. Where portions of the system become damaged or corroded, repairs must be made to reestablish the functioning of the system. Diesel exhaust treatment systems having large diameter pipes require joints that are readily amenable to periodic disassembly for maintenance and reassembly for operation. For example, disassembly of exhaust pipe joints may be required to repair damaged or corroded components, or for replacement of catalysts in catalytic converters or related emission systems.

In many piping systems, particularly exhaust purifying systems which utilize an additional reagent or fluid for NOₓ reduction or filter heating, the connections must be leak-proof. Current sealing systems can experience leaks at an unacceptable level, especially those available for exhaust piping. Improperly directed friction applied to typical V-clamps and mating surfaces can limit the clamping force and result in leakage. Additionally, aligning flanges in current systems is difficult, and misalignment of gaskets during the sealing of the joints is common.

In most current devices for housing catalytic converters, the enclosure or housing is composed of a cylindrical piece of metal (or sheet metal which has been formed into a cylinder and seam welded) with a radial flange welded on each end of the cylinder. However, this method requires two additional welding steps during the manufacturing process to add the flanges.

It would be desirable to develop a pipe joint and method for releasably joining pipes that is economical to construct and use and offers good joining and sealing with easy release when desired; and especially one that is readily repairable if necessary and that does not require gaskets for sealing.

All documents referred to in this application are incorporated by reference into this application.

### SUMMARY OF THE INVENTION

In a first aspect, this invention is a clamped pipe joint comprising:

(a) two pipes, each pipe having a joining end forming an expanded section of the pipe and a partially inwardly facing flare having inner and outer surfaces, the pipes being aligned on a common axis and the joining ends facing each other;

(b) a tubular insert having ends inserted within the expanded sections of the joining ends of the pipes and a ridge between the ends, the ridge having two partially outwardly facing bearing surfaces engaged on annular contact areas with the inner surfaces of the partially inwardly facing flares of the joining ends of the two pipes; and

(c) a clamp having a radially inwardly facing concave groove, fastened with the groove around the ridge of the tubular insert and the outer surfaces of the flares of the two pipes and urging the flares into sealing contact with the bearing surfaces of the insert by radial compression of the clamp.

In a second aspect, this invention is a method for forming the clamped pipe joint of the first aspect of the invention.

In a third aspect, this invention is a clamped pipe joint comprising:

(a) a first pipe having a joining end forming an expanded section of the pipe and a partially inwardly facing flare having inner and outer surfaces;

(b) a second pipe having a joining end forming a ridge proximate the end of the pipe, the ridge having two partially outwardly facing bearing surfaces, the joining end of the second pipe being inserted into the joining end of the first pipe so that a first bearing surface of the ridge of the second pipe engages on an annular contact area with the inner surface of the partially inwardly facing flare of the joining ends of the first pipe; and

(c) a clamp having a radially inwardly facing concave groove, fastened with the groove around the outer surface of the flare of the first pipe and a second bearing surface of the ridge of the second pipe and urging the flare into sealing contact with the bearing surfaces of the ridge by radial compression of the clamp.

In a fourth aspect, this invention is a method for forming the clamped pipe joint of the third aspect of the invention.

In a fifth aspect, this invention is pipes adapted to form the clamped pipe joints of the first and third aspect of this invention.

### BRIEF DESCRIPTION OF THE DRAWINGS

FIG. 1 is an exploded sectional view of the clamped pipe joint of the first aspect of this invention.

FIG. 2 is a sectional view of a partially assembled clamped pipe joint of FIG. 1.

FIG. 3 is a sectional view of a fully assembled clamped pipe joint of FIG. 1.

FIG. 4 is an exploded sectional view of the clamped pipe joint of the first aspect of this invention illustrating the use of gaskets.

FIG. 5 is a sectional view of a partially assembled clamped pipe joint of the third aspect of this invention.

FIG. 6 is a sectional view of a fully assembled clamped pipe joint of FIG. 5.

FIG. 7 is a perspective view of a clamp suitable for this invention.

FIGS. 8 and 9 are sectional views of pipes adapted to form the clamped pipe joints of the first and third aspects of this invention.

### DETAILED DESCRIPTION OF THE INVENTION

Articles such as “the”, “a”, and “an” include the plural as well as the singular.

“Pipe” has the common dictionary meaning of a hollow cylinder, and includes “tube”, “duct” and similar terms. No particular cross-section is implied by the term, but commonly a pipe is of circular cross-section, and the following discussion will refer to such pipes. It will be evident from the following discussion that pipes of non-circular cross-section, for example oval cross-section, can also be releasably connected with the clamped pipe joint and method of this invention. Also, while “pipe”, as that word is generally used, implies just a hollow cylinder, “pipe” as used in this application includes hollow cylindrical sections that act as housings. For example, a “pipe” may be the housing for a filter or catalytic converter for use in the exhaust system of an internal combustion engine, so that the clamped pipe joint of this invention is particularly adaptable to joining exhaust system components. Further, while pipes are generally of constant or relatively constant diameter, the word “pipe” as used in this application also includes pipes having diameters varying along their length, and includes funnel-shaped “pipes” linking sections of relatively small diameter (e.g. 3-10 cm) with sections of relatively large diameter (e.g. 20-40 cm), for example acting as adapters between the tubing as such of an exhaust system and the housing of a muffler, filter, or catalytic converter of the exhaust system.

This invention provides a clamped pipe joint for releasably connecting pipes that is easy to assemble, provides a tight seal to prevent the ingress or escape of fluids (such as the escape of exhaust gases in exhaust systems) under adverse conditions (such as under high temperatures and after a number of heating and cooling cycles), does not involve heavy components, can readily be repaired using simple tools if necessary, and permits simple disassembly for periodic maintenance and service of piping systems and components connected using them. It provides a joint that occupies a minimum volume and that may readily be scaled to accommodate pipes of varying sizes. The components of the clamped pipe joint of this invention, the pipes, inserts, and clamps, can be economically manufactured using standard methods known in the art. It is particularly suitable in the installation and maintenance of retrofit devices (such as mufflers, filters, and catalytic converters) in exhaust systems.

The pipe clamp enables the application of a wide variety of pollution control systems with limited custom engineering. Each unique application will have specific pollution control modules and gas-handling modules which are chosen from the available technology. Pollution control modules include, but are not limited to, NOₓ reducing catalysts, selective catalytic reduction catalysts, diesel oxidation catalysts, diesel particulate filter, partial oxidation catalysts. These modules will be interchangeable within the context of the pipe clamp system, and the various components may be combined in various ways. Gas handling equipment is similarly modular, with exhaust gas recirculation (EGR) elements, sound attenuation modules, mixing modules, inlet sections and outlet sections included in the collection.

In addition, the clamping method makes it possible for a modest number of inlet and outlet adapter shapes to accommodate the very large number of exhaust configurations found on vehicles. Some examples of these configurations are as follows: inlet 90 degrees from outlet on different ends of the device, inlet 90 degrees from outlet on the same end of the device, inlet and outlet on the same end of the device, inlet and outlet on opposite ends of the device. Several more examples can be found in the “2002 Exhaust Product Guide” published by Nelson (Stoughton, Wis., USA). A less desirable alternative is to have a large number of designs with application-specific inlet and outlet portions.

The clamping method also allows for future upgrades of the installed technology. A single or several modules can be very easily replaced by a new module containing new or improved technology. Since the clamping system is designed to be service friendly (no gaskets are necessary, the entire system can remain in the vehicle), these upgrades can be carried out at most facilities with minimal down time. Similarly, the simplicity of the clamped connection provides easy access when servicing other parts of the engine. For example: if a new turbocharger has to be installed the clamped joint can simple be loosened to freely turn the intake cone or module in order to provide access. A less desirable alternative would be the removal of the emissions control system to perform a non-related service.

Additional features and advantages of the invention are written in the description which follows and, in part, will be obvious from the description and may be learned by practice of the invention as described in the application.

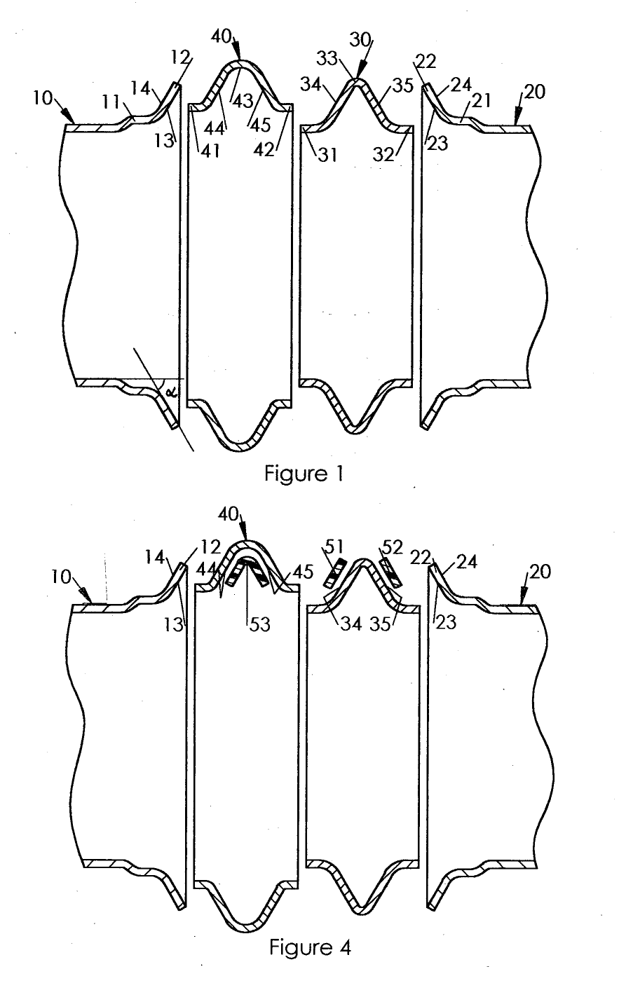

FIGS. 1 through 4 show the clamped pipe joint of the first aspect of this invention.

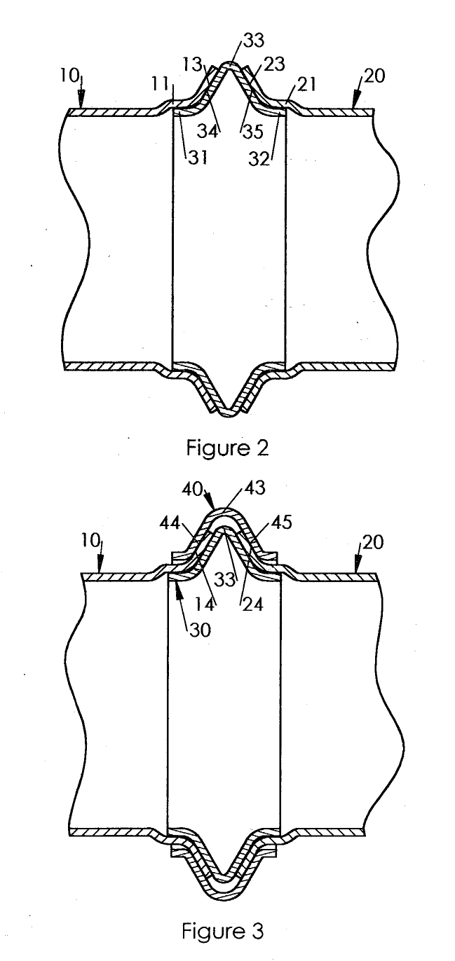

FIG. 1 is an exploded sectional view of the components of the clamped pipe joint of a first aspect of this invention. In this Figure, and in FIGS. 2, 3, and 4, the two pipes to be joined are shown as identical. However, it will be apparent to a person of ordinary skill in the art having regard to that skill and this disclosure that this is not required; and the pipes may be of different materials or wall thicknesses, and/or have a different flare shape or have the flare form a different angle with the pipe axis, and/or even be of somewhat different diameters, so long as the insert and clamp used to join the pipes are shaped to engage with each pipe to be joined (i.e. they may be asymmetrical). Typically, however, the pipes will be essentially identical and the insert and clamp symmetrical.

In FIG. 1, the first pipe shown generally at 10 has a joining end comprising an expanded section 11 of the pipe and a partially inwardly facing flare 12 having an inner surface 13 and an outer surface 14. The expanded section 11 is typically comparatively short, for example it may be as short as 2-4 mm, though it may be longer if desired. The inner diameter of the expanded section is typically greater than the inner diameter of the pipe by about the wall thickness of the insert so that the internal diameter of the pipe is not reduced at the joint. The flare 12 is formed in the joining end of the pipe by a process such as rolling, and typically forms an angle α with the axis of the pipe of 45-75°, especially about 60°, the angle α being shown at the lower portion of the Figure. The second pipe shown generally at 20 has a joining end comprising an expanded section 21 and a partially inwardly facing flare 22 having an inner surface 23 and an outer surface 24. The insert shown generally at 30 has ends 31 and 32, and a ridge 33 between them, the ridge having two partially outwardly facing bearing surfaces 34 and 35, which are angled to correspond to the angle of the flare of the joining ends of the pipes. The clamp shown generally at 40 has ends 41 and 42, having between them a radially inwardly facing concave groove 43 with inner bearing surfaces 44 and 45.

The insert may be made of various materials known in the art, such as from deformable material, for example an engineering plastic such as a polyamide or polyimide (e.g. duPont's Kevlar®), fiber-reinforced plastics (e.g. Fiberglass®), and optionally laminated metal plate or sheet. Typically, the insert is made of a metallic material that is compatible with the flares and the clamp components and which also has structural integrity. The insert may be made of the same or different materials than that of the pipe flares to optimize sealing capability for a variety of different applications. Preferably, the materials are selected to provide a tight seal that resists temperatures and pressure that develops in the exhaust system. To increase the strength of the insert, and hence the strength of the clamped pipe joint, especially when the walls of the pipes to be joined are relatively thin, the insert may be made of a thicker material than the pipes. Also, the ends of the insert may be strengthened, if desired, by beading or doubling back of the material of the insert on itself provided that the additional thickness at the ends of the insert does not interfere with the engagement between the bearing surfaces of the insert and the inner surfaces of the flares on the pipes; though this is not usually necessary and is not shown in the Figures.

The flares on the pipes may also be strengthened, if desired, by beading or doubling back of the wall material provided that the additional thickness at the ends of the flares does not interfere with the engagement between the bearing surfaces of the insert and the inner surfaces of the flares on the pipes, or between the engagement the outer surfaces of the flares and the inner bearing surfaces of the clamp. However, such increase in strength is not typically necessary and is not shown in the Figures, as the strength of the joint is the result of the combination of the clamp, the flares, and the insert.

Although the shape of the ridge of the insert (and the flares of the pipes and the radially inwardly concave groove of the clamp) has been shown in the Figures as relatively straight, by which is meant that the bearing surfaces forming the ridge form a constant angle with the axis of the pipe, a person of ordinary skill in the art will realize that the bearing surfaces need not be straight, and indeed that the ridge can have a more rounded shape, such as a semicircular rather than a V shape. Of course, such a change in the shape of the ridge of the insert will be accompanied by corresponding changes in the shapes of the flares of the joining ends of the pipes and the groove of the clamp to ensure sealing efficiency; and a person of ordinary skill in the art will have no difficulty in designing a suitable shape for the ridge, flares, and groove to achieve an effective clamped pipe joint of this invention.

The pipes, or the ends thereof, may be formed from a hollow cylindrical piece of metal which has had a joining end, or two joining ends, formed thereon. Alternatively, the pipes can be formed from metal sheet or plate that is rolled around a form to form a cylinder with a joining end on each end, and then seam welded. This latter method is particularly attractive when pipes of large diameter are being formed, such as a pipe forming the housing of a component (e.g. a muffler, filter, or catalytic converter) of an exhaust system. Suitable pipes will have a wall thickness about 6 mm or less, typically about 0.5-6 mm, for example 0.5-2 mm, such as 0.5-0.8 mm or 1-2 mm.

The pipes, insert, and clamp will be made of materials suitable for the conditions of use of the clamped pipe joint of this invention. When the joint is to be formed in the exhaust system of an internal combustion engine, which is a specially contemplated use of this invention, typically the pipes, insert, and clamp will be made of materials that are capable of withstanding high temperatures of the exhaust system and are resistant to deterioration over an extended period of time. Non-exclusive, exemplary materials of construction for the pipes, and sealing system include alloys such as inconel and steels such as aluminized carbon steel and stainless steels such as 304L, 409, and 410 stainless steel.

FIG. 2 is a sectional view of a partially assembled clamped pipe joint having the components shown in FIG. 1. In this Figure, the ends 31 and 32 of the insert have been inserted into the expanded sections 11 and 21 of the first and second pipes respectively, thereby reinforcing the joining ends of the pipes at the clamped joint, and the partially outwardly facing bearing surfaces 34 and 35 of the ridge 33 are engaged on annular contact areas with the inner surfaces 13 and 23 of the flares of the first and second pipes respectively. The extent of the annular contact areas depends on the conformance between the bearing surfaces of the ridge of the insert and the inner surfaces of the flares, and can be maximized by suitable attention to the design.

FIG. 3 is a sectional view of a fully assembled clamped pipe joint of FIG. 1. Here, in addition to the assembly of the insert 30 and the joining sections of the two pipes 10 and 20 already shown in FIG. 2, the clamp 40 has been placed so that its radially inwardly facing concave groove 43 overlies the ridge 33 of the insert and the outer surfaces 14 and 24 of the flares of the first and second pipes respectively. Tightening of the clamp produces a radial compression, wedgingly urging the flares of the first and second pipes together, forcing their inner surfaces into sealing contact with the bearing surfaces of the insert, while the insert as a whole reinforces the joining ends of the pipes and permits the application of considerable sealing pressure to maximize the annular contact areas between the bearing surfaces of the insert and the flares.

FIG. 4 is an exploded sectional view of the components of the clamped pipe joint of the first aspect of this invention illustrating the use of gaskets. Although it is an attractive feature of the clamped pipe joint of this invention that direct (for example, metal-to-metal) contact between the flares of the joining ends of the pipes and the insert provides an excellent seal, thereby creating a leaktight clamped joint, without the use of gaskets, it is also contemplated that gaskets can be used if desired. In this Figure, first inner gasket 51 lies between the inner surface 13 of flare 12 and bearing surface 34 of the insert, while second inner gasket 52 lies between the inner surface 23 of flare 22 and bearing surface 35 of the insert. Outer gasket 53 lies between the outer surfaces 14 of flare 12 and 24 of flare 22 and the bearing surfaces 43 and 44 of clamp 50. The first and second inner gaskets may be combined into a single inner gasket overlaying the ridge of the insert if desired, and such a variation will be apparent to a person of ordinary skill in the art and is not illustrated. The outer gasket must be a single piece, because the clamp will have at least one gap in its circumference (and may have more, if it is segmented), and therefore does not itself provide sealing. The gasket(s) can be made of any of the materials conventional in the art, selected according to the uses to be made of the pipe joints, and may for example be made of soft metals or alloys, laminated graphite (e.g. Grafoil®), or (in the case of the inner gaskets) may be coated (such as by spraying) onto the surfaces on which they will be used.

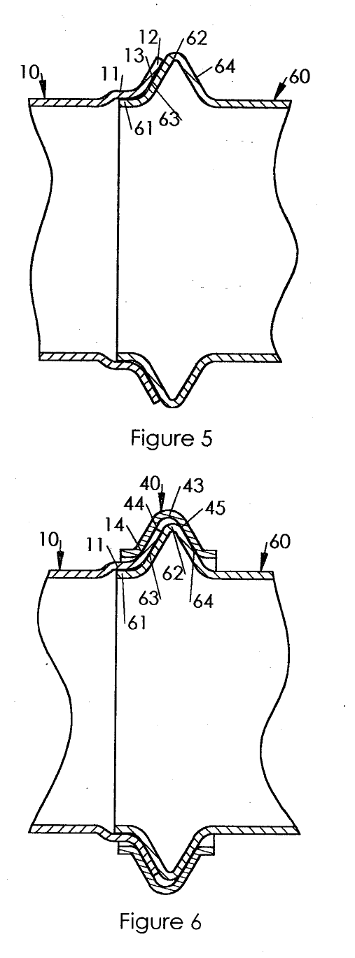

FIGS. 5 and 6 show the clamped pipe joint of the third aspect of this invention.

FIG. 5 is a sectional view of a partially assembled clamped pipe joint of the third aspect of this invention. In this aspect of the invention, a first of the two pipes to be joined has the same configuration as in the first aspect of the invention, while a second of the two pipes has a ridge like that of the insert of the first aspect of the invention, and no insert is used. Thus, the first pipe shown generally at 10 has a joining end comprising an expanded section 11 of the pipe and a partially inwardly facing flare 12 having an inner surface 13 and an outer surface 14. The second pipe shown generally at 60 has a joining section having an end 61 and a ridge 62 proximate the end 61 having two partially outwardly facing bearing surfaces 62 and 63, surface 62 being angled to correspond to the angle of the flare 12. In this Figure, the end 61 of the second pipe 60 has been inserted into the expanded section 11 of the first pipe, thereby reinforcing the joining ends of the pipe at the clamped joint, and the partially outwardly facing bearing surface 63 of the ridge 62 is engaged on an annular contact area with the inner surfaces 13 of the flare of the first pipe.

FIG. 6 is a sectional view of a fully assembled clamped pipe joint of FIG. 5. Here, in addition to the assembly of the joining sections of the two pipes 10 and 60 already shown in FIG. 5, the clamp 40 has been placed so that its radially inwardly facing concave groove 43 overlies the ridge 62 of the second pipe and the outer surfaces 14 of the flare of the first pipe. Tightening of the clamp produces a radial compression, wedgingly urging the flares of the first pipe against the ridge of the second pipe, forcing its inner surface into sealing contact with the bearing surface of the ridge, while the ridge and end of the second pipe reinforces the joining ends of the first pipe and permits the application of considerable sealing pressure to maximize the annular contact areas between the bearing surfaces of the ridge and the flare.

It will be apparent to a person of ordinary skill in the art that the clamped pipe joint of the third aspect of this invention may also be gasketed in a manner similar to that of the clamped pipe joint of the first aspect of this invention, except that only one inner gasket would be used. Other features of the joint (materials of construction, shapes, etc.) will be essentially as discussed above with respect to the joint of the first aspect of this invention.

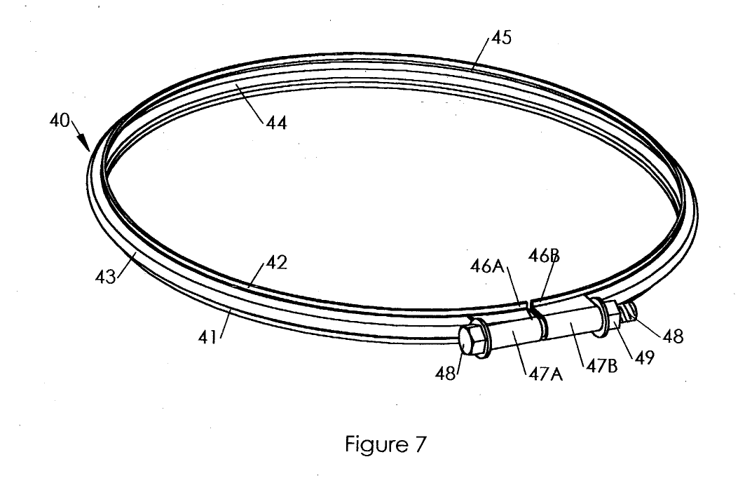

FIG. 7 is a perspective view of a clamp suitable for this invention. FIGS. 1 through 6 have shown only the cross-section of the clamp 40, illustrating the way in which the ring of the clamp fits over the flares and insert or flare and ridge to form the clamped pipe joint; here FIG. 7 shows an exemplary design of the clamp as a whole. The clamp shown is a tension-ring clamp, where a ring of material of the appropriate sectional shape, having an axial split between opposing faces 46A and 46B has barrels 47A and 47B fastened to its exterior proximate the faces for receiving a bolt 48 on which is tightened a nut 49. Tightening of nut 49 on bolt 48 draws the faces together, shortening the circumference of the clamp and hence causing it, when in use, to clamp radially inwardly to form the clamped pipe joint of this invention.

A person of ordinary skill in the art will have no difficulty in determining a suitable design for a clamp usable in this invention. Such clamps may include the two-piece clamps seen, for example, in U.S. Pat. Nos. 3,788,677; Re. 28,912; and 3,964,773; or multi-piece clamps of similar design; but preferred clamps are tension ring clamps in which the clamp is tightened circumferentially, because this produces a more even radial compression by the clamp. Clamps of the tension-ring type are well known for such tasks as clamping lids on barrels and the joining of beaded or flanged pipes, and are widely commercially available; and the design or modification and construction of such a clamp to create a radially inwardly facing concave groove of the appropriate shape to engage the flares of the pipes being joined in the clamped pipe joint of the first aspect of this invention or the flare of one pipe and the ridge of the other being joined in the clamped pipe joint of the third aspect of this invention will be well within the skill of such a person.

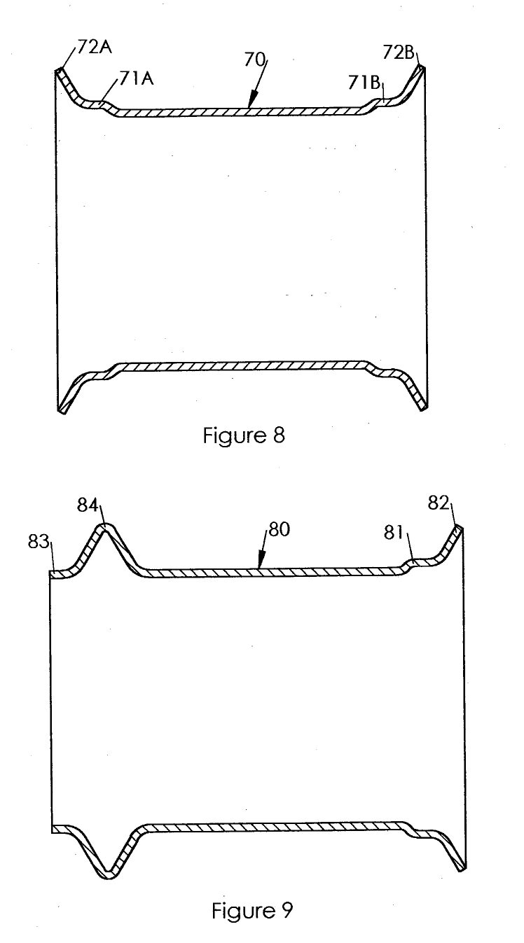

FIGS. 8 and 9 are sectional views of pipes adapted to form the clamped pipe joint of this invention.

In FIG. 8, the pipe shown generally at 70 has at both its ends joining sections like those of pipe 10 of FIGS. 1 through 6. Thus the ends have joining ends having expanded sections 71A and 71B and flares 72A and 72B similar to the expanded section 11 and flare 12 of pipe 10; and the discussion of the joining end of pipe 10 applies to the ends of pipe 70. Pipes of this kind may be joined at either (or both) ends by the clamped pipe joint shown in FIGS. 1 through 3, or by the clamped pipe joint shown in FIGS. 5 and 6. Because the structure of pipe 70 may be symmetrical, it is particularly useful in pipes used simply as pipes for the conveyance of fluids, as a user need not be concerned with asymmetry of the ends.

In FIG. 9, the pipe shown generally at 80 has at one end a joining section like that of pipe 10 of FIGS. 1 through 6 and at the other end a joining end like that of pipe 60 of FIGS. 5 and 6. Thus a first end has a joining end having an expanded section 81 and flare 82 similar to the expanded section 11 and flare 12 of pipe 10, and the discussion of the joining end of pipe 10 applies to this end of pipe 80; while a second end has a joining end having an end 83 and ridge 84 similar to the end 61 and ridge 62 of pipe 60, and the discussion of the joining end of pipe 60 applies to this end of pipe 80. Pipes of this kind may be joined at the first end by the clamped pipe joint shown in FIGS. 1 through 3, or by the clamped pipe joint shown in FIGS. 5 and 6; while they may be joined at the second end only by the clamped joint shown in FIGS. 5 and 6. Because the structure of pipe 80 is asymmetrical, it enables piping systems to be assembled without the use of inserts.

Although the invention has been described in this application with reference to specific and preferred embodiments, which are exemplary of the invention and are not intended to limit the invention, a person of ordinary skill in the art will be able to conceive modifications and variations on these specific embodiments. All such variations and modifications are included within the intended scope of the invention as represented by the claims and their equivalents.

We claim:

1. A clamped pipe joint comprising:
(a) two pipes, each pipe having a joining end forming an expanded section of the pipe and a partially inwardly facing flare having inner and outer surfaces, the pipes being aligned on a common axis and the joining ends facing each other;
(b) a tubular insert having ends inserted within the expanded sections of the joining ends of the pipes and a ridge between the ends, the ridge having two partially outwardly facing bearing surfaces engaged on annular contact areas with the inner surfaces of the partially inwardly facing flares of the joining ends of the two pipes; and
(c) a clamp having a radially inwardly facing concave groove, fastened with the groove around the ridge of the tubular insert and the outer surfaces of the flares of the two pipes and urging the flares into sealing contact with the bearing surfaces of the insert by radial compression of the clamp.

2. The clamped pipe joint of claim 1 where each flare forms an angle of about 45-75° with the axis of its pipe.

3. The clamped pipe joint of claim 2 where each flare forms an angle of about 60° with the axis of its pipe.

4. The clamped pipe joint of claim 1 where the clamp is a tension-ring clamp.

5. The clamped pipe joint of claim 1 further comprising a gasket positioned between a bearing surface of the insert and the inner surface of the flare of a pipe.

6. The clamped pipe joint of claim 1 where the pipes and insert are all formed from metal plate or sheet of the same thickness.

7. The clamped pipe joint of claim 1 where the pipes and insert have a wall thickness of not more than about 6 mm.

8. The clamped pipe joint of claim 7 where the pipes have a wall thickness of about 1-2 mm.

9. The clamped pipe joint of claim 1 where the pipes, insert, and clamp are made from materials that are stable and corrosion-resistant under the conditions of an internal combustion engine exhaust system.

10. The clamped pipe joint of claim 9 where the materials are selected from the group consisting of aluminized carbon steel, inconel, and 304L, 409, and 410 stainless steel.

11. The clamped pipe joint of claim 1 where at least one pipe is the housing of a component of an internal combustion engine exhaust system.

12. The clamped pipe joint of claim 11 where the component is a catalytic converter.

13. The clamped pipe joint of claim 11 where the component is a particulate collecting filter.

14. The clamped pipe joint of claim 11 where the component is a static mixer.

15. The clamped pipe joint of claim 11 where the component is a sound-attenuation device.

16. A method to form a clamped pipe joint connecting two pipes, each pipe having a joining end forming an expanded section of the pipe and a partially inwardly facing flare having inner and outer surfaces, the pipes being aligned on a common axis and the joining ends facing each other, comprising:
(a) inserting within the expanded sections of the joining ends of the pipes the ends of a tubular insert having a ridge between its ends, the ridge having two partially outwardly facing bearing surfaces engagable on annular contact areas with the inner surfaces of the partially inwardly facing flares of the joining ends of the two pipes;
(b) placing around the ridge of the tubular insert and the outer surfaces of the flares of the two pipes a radially inwardly facing concave groove of a clamp adapted to urge the flares into sealing contact with the bearing surfaces of the insert by radial compression of the clamp; and
(c) tightening the clamp.

17. A clamped pipe joint comprising:
(a) a first pipe having a joining end forming an expanded section of the pipe and a partially inwardly facing flare having inner and outer surfaces;
(b) a second pipe having a joining end forming a ridge proximate the end of the pipe, the ridge having two partially outwardly facing bearing surfaces, the joining end of the second pipe being inserted into the joining end of the first pipe so that a first bearing surface of the ridge of the second pipe engages on an annular contact area with the inner surface of the partially inwardly facing flare of the joining end of the first pipe; and
(c) a clamp having a radially inwardly facing concave groove, fastened with the groove around the outer surface of the flare of the first pipe and a second bearing surface of the ridge of the second pipe and urging the flare into sealing contact with the bearing surfaces of the ridge by radial compression of the clamp.

18. A method to form a clamped pipe joint between two pipes, a first pipe having a joining end forming an expanded section of the pipe and a partially inwardly facing flare having inner and outer surfaces, and a second pipe having a joining end forming a ridge proximate the end of the pipe, the ridge having two partially outwardly facing bearing surfaces, the method comprising:
(a) inserting the joining end of the second pipe into the joining end of the first pipe so that a first bearing surface of the ridge of the second pipe engages on an annular contact area with the inner surface of the partially inwardly facing flare of the joining end of the first pipe;
(b) placing around the outer surface of the flare of the first pipe and a second bearing surface of the ridge of the second pipe a radially inwardly facing concave groove of a clamp adapted to urge the flare of the first pipe into sealing contact with the bearing surfaces of the ridge of the second pipe by radial compression of the clamp; and
(c) tightening the clamp.

19. A pipe having at each end a joining end forming an expanded section of the pipe and a partially inwardly facing flare.

20. A pipe having:
(a) at a first end, an expanded section of the pipe, the expanded section having an internal diameter that is greater than the outer diameter of the pipe that is not at the ends of the pipe, and a partially inwardly facing flare; and
(b) at a second end, a ridge proximate the end of the pipe, the ridge having two partially outwardly facing bearing surfaces.
